(19) United States
(12) Patent Application Publication
(10) Pub. No.: US 2013/0326131 A1
(43) Pub. Date: Dec. 5, 2013

(54) Method for Security Context Switching and Management in a High Performance Security Accelerator System

(71) Applicants: Amritpal Singh Mundra, Dallas, TX (US); Denis Beaudoin, Rowlett, TX (US); Eric Lasmana, Plano, TX (US)

(72) Inventors: Amritpal Singh Mundra, Dallas, TX (US); Denis Beaudoin, Rowlett, TX (US); Eric Lasmana, Plano, TX (US)

(73) Assignee: TEXAS INSTRUMENTS INCORPORATED, Dallas, TX (US)

(21) Appl. No.: 13/482,785

(22) Filed: May 29, 2012

(51) Int. Cl. G06F 12/08; G06F 12/00

(52) U.S. Cl. 711/104; 711/131; 711/E12.001; 711/E12.048

(57) ABSTRACT

A security context management system within a security accelerator that can operate with high latency memories and can provide line-rate processing on several security protocols. The method employed hides the memory latencies by having the processing engines working in a pipelined fashion. It is designed to auto-fetch security context from external memory, and will allow any number of simultaneous security connections by caching only limited contexts on-chip and fetching other contexts as needed. The module does the task of fetching and associating security context with ingress packet, and populates the security context RAM with data from the external memory.

### TECHNICAL FIELD OF THE INVENTION

The technical field of this invention is high speed security accelerator systems

### ACRONYMS AND ABBREVIATIONS USED

RFC Request For Comment
PDSP Packed Data Structure Processor
RISC Reduced Instruction Set Controller
IPSEC Internet Protocol Security
SRTP Secure Real-time Transport protocol
SSL Secure Socket Layer
TLS Transport Layer Security
3GPP 3rd Generation Partnership Project
IETF Internet Engineering Task Force
NIST National Institute of Standards and Technology
AES Advance Encryption Standard
DES Data Encryption Standard
SHA Secure Hash Algorithm
MD5 Message Digest 5
FIPS Federal Information Processing System
HMAC Hashed Mac Authentication Code
PDSP Packet Data Structure Processor
SOP Start Of Packet
MOP Middle Of Packet
EOP End Of Packet
SC Security context pointer holding data structure in host memory
CPPI Communication Processor Peripheral Interface
CDMA CPPI DMA controller
RNG Random Number Generator
PKA Public Key Accelerator

### BACKGROUND OF THE INVENTION

The Adaptive Cryptographic Engine (ACE) module shown in FIG. 1 is compliant with various cryptographic standards as defined by the Internet Engineering Task Force (IETF) and National Institute of Standard and Technology (NIST). This compliance has been verified by running compliance test vector suite and comparing the response with expected response.

The ACE subsystem is designed to meet authenticity and confidentiality requirement as defined by various security protocol stacks like IPSEC, SRTP and 3GPP to secure data communication channels. All supported cryptographic protocol stacks meet industry standards that are defined by IETF or NIST, and ACE if fully compliant with these standards.

Control path processing in ACE is carried in the Packet header processing (PHP) subsystem which is equipped with a PDSP (RISC CPU). Firmware running on the PDSP extracts and inspects security headers as per the security protocol stack (IPSEC/SRTP/3GPP etc.) to define the action to be carried out on the packet. If the packet passes the header integrity check then the header processor subsystem sets the route for payload processing within ACE by adding a command label in a pre-defined format in the data buffer holding the packet that is used by other hardware modules to forward the packet to an appropriate engine.

Data path processing is carried out by various data processing subsystems that are partitioned based on the nature of the processing done by the subsystem. ACE has three major data processing subsystems: The Encryption subsystem, Authentication subsystem and the Air cipher subsystem. Packets are forwarded to an individual subsystem by decoding the command label prefixed in front of the packet. The host could optionally engage any data path component by prefixing a command label in front of the packet thereby bypassing PDSP based processing.

The Encryption subsystem carries out the task of encrypting/decrypting payload using hardware cryptographic cores. The Encryption subsystem has an AES core, a 3DES core and a Galois multiplier core which is operated in conjunction with the MCE (mode control engine). The mode control engine implements various encryption modes such as ECB, CBC, CTR, OFB, GCM etc.

The authentication subsystem fulfills the requirement of providing integrity protection. The Authentication subsystem is equipped with a SHA1 core, MD5 core, SHA2-224 core and a SHA2-256 core to support keyed (HMAC) and non-keyed hash calculations.

The Air cipher subsystem secures data sent to wireless devices over the air by using wireless infrastructure defined cryptographic cores like Kasumi or Snow3G. This subsystem is also used to decrypt the data as received from the air interface modules.

Each control and data path processing engine has a context RAM to store the control information pertaining to a logical connection. The context RAM holds information like encryption keys, partial data etc. for each active context. Cryptographic engines provide the option to store 64 numbers of context on-chip based on performance requirements. The context RAM is coupled with the context cache module 101 shown on FIG. 1 to fetch the context information from external memory to populate the active context on a real-time demand basis.

ACE accepts packets from the PA (packet accelerator) port and from the CDMA port as part of the input flow by the streaming interface. Each packet destined to ACE must be prefixed with a software control word that holds information about the security context that is required to uniquely identify a security connection and associated security parameters. ACE expects coherency to be maintained by the DMA; in other words, new packets can only start after the last packet is completely fetched by the ACE.

ACE internally breaks received packet from ingress port (PA/CDMA) to data chunks. Each data chunk can hold a maximum of 256-bytes of packet payload. This chunking operation is required to ensure all hardware engines are fully engaged and to reduce internal buffer (RAM) requirements. ACE works in flow-through mode where the data is processed as and when received without waiting for a complete packet to be stored.

The initial route in ingress flow within ACE is determined by the engine ID that is extracted from the CPPI software word. Subsequent sequence processing of the data chunk is determined by the command label prefixed to chunk by the Host or the PHP (packet header processor) module. The command label holds the engine select codes with optional parameters. Multiple command labels can be cascaded to allow a chunk to be routed to multiple engines within the subsystem to form a logical processing chain. Optional parameters of the command labels are control information pertaining to each processing engine.

ACE allows processing of interleaved data chucks, but always ensures that chunks of same packets follows same route within the system thereby maintaining packet data coherency. Chunks are routed to next engine based on the command label and it's possible to route a chunk back to the same engine for second stage processing.

Once chunks are processed they are queued for Egress to exit ACE. ACE has two physical egress ports (PA and CDMA), and the internal hardware ensures that a packet entering the PA ingress port can only exit through the PA egress port, likewise for the CDMA port. As packets in ACE are processed in chunks, it's possible that chunks belonging to different packets may cross each other in time, i.e. a data chunk of the last received packet may come out first on Egress before the first packet data chunk; therefore ACE has 16 Egress CPPI DMA channels and internal hardware ensures that all data chunks belonging to an individual packet go on the same Egress CPPI DMA channel and thus always maintain packet data coherency on a given CPPI DMA channel.

ACE also hosts TRNG (True Random Number Generator) and PKA (Public Key Accelerator) modules that can be accessed via memory mapped registers by the PDSP or the host to aid in key generation and computation.

### SUMMARY OF THE INVENTION

A security context management system within a security accelerator that can operate with a high latency memory but can provide line-rate processing on several security protocols. The method hides the latencies by having the processing engines working in a pipelined fashion. This way every engine is busy processing a packet while the context module fetches the security context for the next operation.

The context management module is designed to auto-fetch security context from external memory. It allows any number of simultaneous security connections by caching only limited contexts on-chip and fetching other contexts as needed. The module does the task of fetching and associating security context with ingress packets. It populates the security context RAM with data from the external memory, and the fetch size is based on the security context parameters. The module is also designed to perform auto-evict to provide free space for new connections.

The module allows two-tiers of security connections: first tier has permanent residence within the context RAM and never evicted automatically. The second tier contexts are kept until space in context RAM is full and there is a new connection that needs to fetch another security context. In this case the old context is automatically evicted into external memory.

Each request to the context module along with security parameter will trigger a search in the internal cache table. If the lookup fails then a DMA operation is started to populate the security context, else the cached version of the context is used for processing the packet.

### BRIEF DESCRIPTION OF THE DRAWINGS

These and other aspects of this invention are illustrated in the drawings, in which:

FIG. 1 shows a high level block diagram of the Adaptive Cryptographic Engine, and

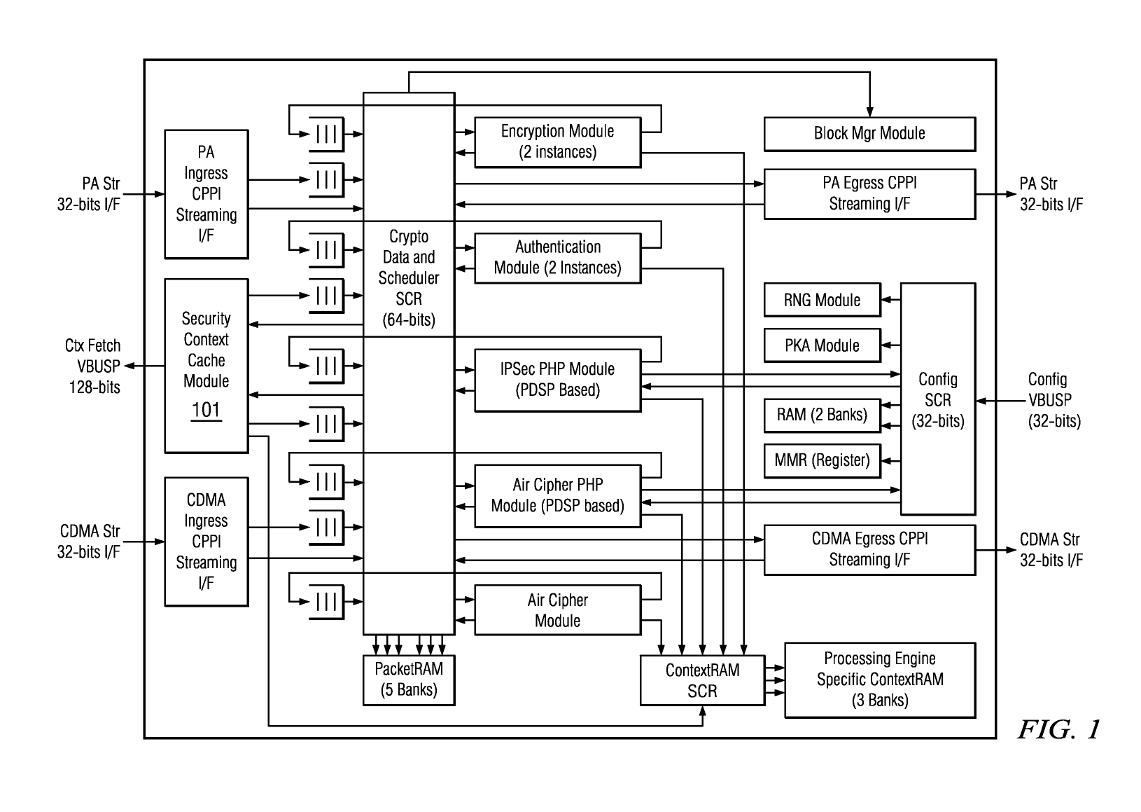

FIG. 2 is a block diagram of one implementation of the context cache module.

### DETAILED DESCRIPTION OF PREFERRED EMBODIMENTS

ACE is equipped with a context cache module to auto-fetch security context from external memory. This module is essential to allow simultaneous security connections by caching only limited contexts on-chip and fetching other contexts as and when required for processing.

The context cache module does the task of fetching and associating security context with ingress packets. The context cache module populates the security context RAM with data to/from the an external memory based on the security context parameters. The context cache module is designed to carry out auto evict and auto fetch to provide free space for new connections.

In order to facilitate fast retrieval for performance critical connections, the context cache module allows two tiers of security connections. The first tier has permanent residence within the context cache RAM for fast retrieval and is never evicted automatically by the context cache module; the host has the option to force eviction. A first Tier connection is established by setting the “first tier bit” when setting up the security context.

Second tier connections are kept while space is available within the context cache RAM; a new fetch request will automatically evict the second tier connections into external memory to provide free space.

Each request to the context cache module along with security parameters will trigger a search in the internal cache table. If the lookup fails then a DMA operation is started to populate the security context else the cached version of the security context is used for processing the packet.

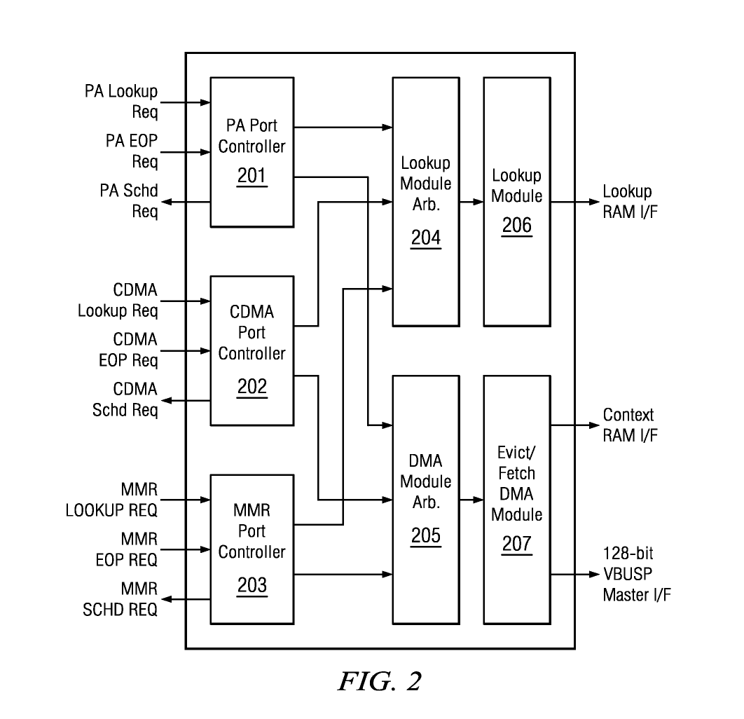

FIG. 2 shows the block diagram of one implementation of the context cache module where block 201 is the Packet Accelerator port controller, block 202 is the CDMA port controller and block 203 is the Memory Mapped Register port controller. The port controllers connect to the Lookup Arbitration block 204 and to the DMA Arbitration block 205. The output of the Lookup Arbitration module 104 connects to Lookup Module 206 which module interfaces to the lookup ram. DMA Arbitration module 205 connects to the Evict/Fetch DMA module 207. Module 207 interfaces to the context ram, and to the system memory bus.

The context cache module expects a 32-bit security context pointer (SCPTR), a 16-bit security context ID (SCID), along with control flags and other data with each request.

The 32-bit security context pointer is a physical external memory address that is used to fetch the security context.

The 16-bit security context ID has the MSB as the “first tier bit” and the remaining 15-bits as the security index (SCIDX). The MSB (first tier) may be set to indicate that this is a first tier connection. The context cache module uses the 15-bit security Index (SCIDX) to search an internal table for locally cached security context. If the search results in success then the locally cached security context is used to process the packet; else a DMA fetch request is issued from the 32-bit security context pointer (SCPTR) to internal cache memory to populate the security context.

The context cache module supports passing control flags along with requests to override the default behavior. Control flags are “Force Evict”, “Force Teardown” and “SOP”.

Table 1 describes the action taken by the context cache module based on the control flags.

TABLE 1

| Force | Force | |
|---|---|---|
| Evict | Teardown | Action |
| 0 | 0 | Normal operation |
| 0 | 1 | Teardown current security context after all |
| | | outstanding packets within ACE system pertaining |
| | | to this particular security context have been |
| | | processed. In this mode context cache module |
| | | clears “Owner” bit in SCCTL header in external |
| | | memory thereby handing security context ownership |
| | | back to “Host”. Clearing of “Owner” bit by |
| | | hardware is indication to Host that Teardown |
| | | operation has been completed. In this scenario |
| | | context cache module only write 32-bytes |
| | | essentially to clear the “Owner bit”. |
| 1 | 0 | Evict current security context to external memory |
| | | after all outstanding packets within ACE system |
| | | pertaining to this particular security context |
| | | have been processed. In this mode context cache |
| | | module looks at “Evict PHP count” in SCCTL to |
| | | determine the numbers of bytes (0, 64, 96 or 128) |
| | | to be evicted. Clearing of “Evict done” bits by |
| | | hardware is indication to Host that Evict |
| | | operation has been completed. Evict operation will |
| | | free currently occupied context cache location. |
| 1 | 1 | Teardown and Evict current security context after |
| | | all outstanding packets within ACE system |
| | | pertaining to this particular security context |
| | | have been processed. In this mode context cache |
| | | module clears “Owner” bit and “Evict done” bits in |
| | | SCCTL header in external memory thereby handing |
| | | security context ownership back to “Host”. |
| | | Clearing of “Owner” bit and “Evict done” bit by |
| | | hardware is indication to Host that Teardown/Evict |
| | | operation has been completed. |
| | | In this mode context cache module looks at “Evict |
| | | PHP count” in SCCTL to determine the numbers of |
| | | bytes (0, 64, 96 or 128) to be evicted. If “Evict |
| | | count” is 0 then context cache module writes 32- |
| | | bytes essentially to clear the “Owner bit”. |

Each of the processing engines such as the encryption subsystem, authentication subsystem, air cipher subsystem and header processing subsystem have their own security context RAM that holds the control information required to process ingress data blocks. This context RAM is populated by the cache control module by splitting the host data structure for the connection into an engine specific data structure.

The individual security contexts for connections in host memory are made up of three parts: software only section, packet header processing subsystem section and data processing subsystem section.

The software only section holds the information that is used by the software (DSP code) for managing security context and for storing connection specific data, and this information is not fetched by ACE.

The second section holds packet header processing subsystem specific control information; this is used by the packet header processing (PHP) subsystem within ACE to maintain the current state of the connection along with data required to process packets. This section is optionally fetched and updated by ACE module using DMA as and when required.

The third and forth sections holds data processing subsystem (encryption subsystem, authentication subsystem and/or air cipher subsystem) specific control and state information. This section is optionally fetched by ACE module as and when required. ACE never updates the data processing subsystem sections.

The first fetchable section of the security context has the security context control word (SCCTL) that details the size, ownership and control information pertaining to security context. This information is populated by the host.

The SCCTL structure is shown in Table 2.

TABLE 2

| Field | source | Width | Description |
|---|---|---|---|
| Owner | Host/ | 1-bits | Context Owner bit, 0 = Host, 1 = ACE. |
| | hard- | | Host must handover ownership to ACE |
| | ware | | before pushing any packet for given |
| | | | context. After Teardown ACE relinquishes |
| | | | ownership back to Host by clearing this |
| | | | bit. Host can only set this bit, ACE can |
| | | | only clear the bit. Context cache module |
| | | | always looks at this bit during fetch |
| | | | operation, If this bit is “0” then the |
| | | | packets are marked as error and |
| | | | forwarded to default queue. |
| Evict | Host/ | 7-bits | All 7-bits are set to zero when evict |
| done | hard- | | operation is completed. |
| | ware | | |
| Fetch/ | Host | 8-bits | This 8-bits info details the sections |
| Evict | | | within security context information |
| size | | | that need to fetched/evicted. |
| | | | [1:0] bits = Fetch PHP bytes |
| | | | 00 = Reserved (Must not be used) |
| | | | 01 = 64 bytes |
| | | | 10 = 96 bytes |
| | | | 11 = 128 bytes |
| | | | [3:2] bits = Fetch Encr/Air Pass 1 |
| | | | 00 = 0 bytes |
| | | | 01 = 64 bytes |
| | | | 10 = 96 bytes |
| | | | 11 = 128 bytes |
| | | | [5:4] bits = Fetch Auth bytes or |
| | | | Encr/Air Pass 2 |
| | | | 00 = 0 bytes |
| | | | 01 = 64 bytes |
| | | | 10 = 96 bytes |
| | | | 11 = 128 bytes |
| | | | [7:6] bits = Evict PHP bytes |
| | | | 00 = 0 bytes |
| | | | 01 = 64 bytes |
| | | | 10 = 96 bytes |
| | | | 11 = 128 bytes |
| Reserved | Hard- | 16-bits | Security context ID, filled by Hardware. |
| (SCID) | ware | | |
| Reserved | Hard- | 32-bits | Security context pointer, filled by |
| (SCPTR) | ware | | Hardware. |

Table 3 shows the security context for IPSEC mode as seen by the host software, using SG/MD5 and AES/3DES. Flow is the same for both inbound and outbound data.

TABLE 3
Software only section (not fetched by ACE) (64-bytes)
SCCTL (8-bytes)
Packet Header processor (PHP) module specific section.
(fetched by ACE) (56-bytes)
Used for IPSEC header processing using PDSP and CDE engine
PHP Pass1/Pass2 Engine ID
Encryption module specific section. (fetched by ACE) (96-bytes)
Used for IPSEC encryption using AES/3DES core.
Encryption Pass1 Engine ID.
Authentication module specific section. (fetched by ACE) (96-bytes)
Used for IPSEC Authentication using SHA/MD5 core.
Authentication Pass1 Engine ID.

Table 4 shows the security context for SRTP as seen by the host software. This context uses SHA/MD5 and AES/3DES. Data flow is the same for both inbound and outbound data.

TABLE 4
Software only section (not fetched by ACE) (64-bytes)
SCCTL (8-bytes)
Packet Header processor (PHP) module specific section.
(fetched by ACE) (120-bytes)
Used for SRTP header processing using PDSP and CDE engine.
PHP Pass1/Pass2 Engine ID.
Encryption module specific section. (fetched by ACE) (64-bytes)
Used for SRTP encryption using AES/3DES core.
Encryption Pass1 Engine ID
Authentication module specific section. (fetched by ACE) (64-bytes)
Used for SRTP Authentication using SHA/MD5 core.
Authentication Pass1 Engine ID

Table 5 shows the security context for Air Cipher outbound, where encryption (Kasumi-F8) is done first, followed by authentication using Kasumi-F9. The same hardware engine is used twice for, for encryption and authentication.

TABLE 5
Software only section (not fetched by ACE) (64-bytes)
SCCTL (8-bytes)
Packet Header processor module specific section.
(fetched by ACE) (56-bytes)
Used for Air cipher header processing using PDSP and CDE engine.
PHP Pass1/Pass2 Engine ID.
Air cipher module specific section. (fetched by ACE) (64bytes)
Used for Air cipher encryption using Kasumi/AES/Snow3G core.
(Example: Kasumi-F8)
AirC Pass1 Engine ID.
Air cipher module specific section. (fetched by ACE) (64bytes)
Used for Air cipher integrity protection using Kasumi/AES/
Snow3G core. (Example: Kasumi-F9)
AirC Pass2 Engine ID

Table 6 shows the security context for air cipher inbound, where authentication is done first using Kasumi-F9 followed by encryption using Kasumi-F8. The same hardware engine is used twice, for authentication and encryption.

TABLE 6
Software only section (not fetched by ACE) (64-bytes)
SCCTL (8-bytes)
Packet Header processor module specific section.
(fetched by ACE) (56-bytes)
Used for Air cipher header processing using PDSP and CDE engine.
PHP Pass1/Pass2 Engine ID
Air cipher module specific section. (fetched by ACE) (64bytes)
Used for Air cipher integrity protection using Kasumi/AES/
Snow3G core. (Example: Kasumi-F9)
AirC Pass1 Engine ID
Air cipher module specific section. (fetched by ACE) (64bytes)
Used for air cipher encryption using Kasumi/AES/Snow3G core.
(Example: Kasumi-F8)
AirC Pass2 Engine ID

The cache algorithm is used by the hardware to manage caching of the security context. This module implements a four way cache, where the LS 4-bits of the context-ID acts as the cache way select. Once cache way has been identified, then four comparisons are done within the selected cache way to look for a security ID match.

If a security ID matches with either of the four stored cache way, then the context is believed to be locally cached. If the lookup fails then the security context is fetched and the first empty cache way is loaded with data from the current security context. If there is no empty slot found within the selected cache way then the hardware evicts the last non-active security context which is not a “First Tier”.

In order to avoid deadlocking the hardware will not allow marking all four contexts within a given cache way as “First Tier”. The last “First Tier” request is ignored if the remaining three contexts are “First Tier”.

In order to efficiently use the caching mechanism, it is recommended to use linearly incremented security context ID's for new connections.

What is claimed is:

1. A context cache system comprising:
a packet accelerator port controller;
a CDMA port controller;
a memory mapped register port controller;
a lookup arbitration module;
a DMA arbitration module;
a memory lookup module; and
an evict and fetch cache management DMA module.

2. The context cache system of claim 1 wherein:
the packet accelerator port controller is connected to the lookup arbitration module and further connected to the DMA arbitration module;
the CDMA port controller is connected to the to the lookup arbitration module and further connected to the DMA arbitration module; and
the memory mapped register port controller is connected to the lookup arbitration module and further connected to the DMA arbitration module.

3. The context cache system of claim 1 wherein:
the lookup arbitration module is connected to the memory lookup module; and
the DMA arbitration module is connected to the evict and fetch DMA module.

4. The context cache system of claim 1 wherein:
the context cache system is operable to read from or write to the security context ram from external memory based on the security context parameters received through one of the port controllers.

5. The context cache system of claim 1 wherein:
the context cache system is operable to assign one of two priority levels to the security context stored within the context cache where a high priority level context will remain in the cache until removed by a host while a low priority security context may be replaced by new context if memory space is needed.

6. The context cache system of claim 1 wherein:
each request to the context cache system will generate a search of the internal cache management table to either retrieve the cached security context or to initiate a DMA request for retrieving the security context from memory.
